(19) United States
(12) Patent Application Publication
(10) Pub. No.: US 2009/0308512 A1
(43) Pub. Date: Dec. 17, 2009

(54) Pneumatic Tire

(76) Inventor: Norihiko Nakamura, Osaka (JP)

Correspondence Address: FISH & RICHARDSON P.C., P.O. BOX 1022, MINNEAPOLIS, MN, 55440-1022, US

(21) Appl. No.: 12/441,428

(22) PCT Filed: Aug. 7, 2007
(86) PCT No.: PCT/JP2007/065421

§ 371 Date: Apr. 2, 2009

(30) Foreign Application Priority Data
Sep. 27, 2006 (JP) 2006-263378

(51) Int. Cl. B60C 19/08

(52) U.S. Cl. 152/152.1

(57) ABSTRACT

A pneumatic tire that can be manufactured according to the conventional method without requiring special tire manufacturing steps and without needing addition of material members and production steps, has excellent rolling resistance and wet properties, and has conductivity. The pneumatic tire 10 has a sheet-like cushion rubber 25 having a thickness of 1 mm or less, disposed on a tire inside face side of a side wall rubber, the cushion rubber 25 is in contact with a rim strip 19 and exposed to a surface of a ground contact edge region of a tread part 13 through a side wall part 16, and is characterized in that on the circumference of unilateral or bilateral side portions of the tire 10, the rim strip 19 and the cushion rubber 25 are formed into a continuous conductive path by a conductive rubber material, only the conductive path is used as a conducting path of the tire 10, and members other than the conducting path are selected and used from a conductive rubber material or a nonconductive rubber material.

### TECHNICAL FIELD

The present invention relates to a pneumatic tire. More particularly, the invention relates to a pneumatic tire manufactured by the conventional process, that has a tread of silica compounding or the like, improves rolling resistance and wet properties of a tire, and can discharge static electricity charged in vehicles to road surface.

### BACKGROUND ART

To improve rolling resistance and running performance (wet properties) on wet road surface of a pneumatic tire, the technology of compounding silica with a rubber composition of a tread as a reinforcing agent in place of the conventional carbon black is known. With this silica compounding technology, static electricity charged in vehicles gives rise to the problems that discharge phenomenon is generated when a tire passes on manholes and the like, resulting in radio noise, adverse influence to electronic circuit parts, generation of short-circuit, and the like.

Conventionally, to solve those problems, the technology of providing a conductive member having carbon black compounded therein in a part of a tread structure, thereby securing conductivity of a tire is proposed. For example, the technology of Patent Document 1 below describes that a conductive thin film containing carbon black is arranged on the outer surfaces of a tread and a side wall, thereby discharging through this conductive layer. Furthermore, the technology of Patent Document 2 discloses that a conductive insert is provided on a tire crown part over from a tread surface to a bottom, and a conductive strip comprising a conductive material being in contact with this insert is in a contact state with a wheel in a conductive bead region, thereby discharging static electricity.

Patent Document 1: JP-A-8-230407

Patent Document 2: JP-A-2006-143208

### DISCLOSURE OF THE INVENTION

### Problems that the Invention is to Solve

However, the technology of Patent Document 1 is that improvement effects on rolling resistance and wet properties of a tread by silica compounding are decreased by arranging the above-described conductive thin film containing carbon black, and it is difficult to sufficiently exhibit the original effect. Furthermore, from that the conductive thin film containing carbon black is arranged on the outer surfaces of a tread and a sidewall, additional material members and process steps are required, and deterioration of productivity and increase in costs are predicted.

The technology of Patent Document 2 requires to separately providing conductive insert and strip. Therefore, the number of members is increased, and special process steps are required. Thus, it is difficult to say that such a tire has a structure that is easily produced, and decrease in productivity is predicted.

In view of the above problems, the object of the invention is to provide a pneumatic tire, that can be manufactured according to the conventional process without requiring special tire manufacturing steps and without needing addition of material members and process steps, has excellent rolling resistance and wet properties, and has conductivity.

### Means for Solving the Problems

The invention described in claim 1 is a pneumatic tire having a sheet-like cushion rubber having a thickness of 1 mm or less, disposed on a tire inside face side of a side wall rubber, the cushion rubber being in contact with a rim strip and coupled to a ground contact edge region of a tread part through a side wall part, characterized in that on the circumference of unilateral or bilateral side portions of the tire, the rim strip, the cushion rubber and at least the surface part of the ground contact edge region are formed into a continuous conductive path by a conductive rubber material, only the conductive path is used as a conducting path of the tire, and members other than the conducting path are selected and used from a conductive rubber material or a nonconductive rubber material.

The invention claimed in claim 2 is the pneumatic tire as claimed in claim 1, characterized in that the outward edge in a radial direction of the tire of the side wall integrally forms the ground contact edge region, and the top part of the cushion rubber is exposed to the surface of the ground contact edge region.

The invention claimed in claim 3 is the pneumatic tire as claimed in claim 1, characterized in that the tire has a wing disposed at both edges in an axial direction of the tire of the tread part and contacted with the side wall to form the surface part of the ground contact edge region, and the top part of the cushion rubber is contacted with the wing.

The invention claimed in claim 4 is the pneumatic tire as claimed in any one of claims 1 to 3, characterized in that the conductive rubber material is a rubber composition having electric resistivity less than 10⁸Ω·cm.

The invention claimed in claim 5 is the pneumatic tire as claimed in claim 4, characterized in that the rubber composition comprises a diene rubber as a rubber component, and carbon black having a nitrogen adsorption specific area of from 25 to 100 m²/g in an amount of 14 vol % or more of the entire rubber composition.

The invention claimed in claim 6 is the pneumatic tire as claimed in claim 1, characterized in that the nonconductive rubber material comprises a rubber composition containing a non-carbon black reinforcing agent as a reinforcing agent.

The invention claimed in claim 7 is the pneumatic tire as claimed in claim 6, characterized in that the non-carbon black reinforcing agent is silica.

### ADVANTAGE OF THE INVENTION

By using the cushion rubber disposed on the tire inside face side of the side wall as a conducting path in order to improve adhesion between different kinds of rubbers, such as a side wall rubber, a carcass and a rim strip rubber, the pneumatic tire of the present invention can provide a tire having conductivity while additionally having excellent rolling resistance and wet properties due to silica compounding, that can be manufactured by the conventional process without requiring any special tire manufacturing step as disclosed in the prior art, and without needing addition of material members and process steps, and can eliminate problems such as noises, adverse influence to electronic parts, and short-circuit, due to static electricity charged in vehicles using a nonconductive tire of silica compounding or the like.

### BEST MODE FOR CARRYING OUT THE INVENTION

The embodiments of the present invention are described below.

### First Embodiment

FIG. 1 is a semi-sectional view showing a pneumatic tire of a first embodiment.

The pneumatic tire (hereinafter, a pneumatic tire is simply referred to as a “tire”) 10 comprises a pair of bead parts 11 to be mounted on a rim, a side wall part 16 extending outward in a radial direction of the tire from the bead part 11, and a tread part 13 ground-contacted to road surface laid between the side wall parts 16, 16, and the tread part 13 comprises a crown part 15 constituting a main ground contact part at the central portion in a width direction of the tire, and a shoulder part 17 positioned at both sides of the tread part 13 to form a ground contact edge region and being continuous to the side wall part 16.

The tire 10 has a rim strip 19 contacting with a flange of a rim provided outward in an axial direction of the tire of the bead part 1, and the lower edge of the side wall part 16 is contacted with the rim strip 19 by overlapping on the upper edge thereof.

The tire 10 has a side wall-on-tread (SWOT) structure in which the outward edge in a radial direction of the tire of the side wall part 16 is overlapped on the edge of a tread rubber 21, as shown in FIG. 1. Specifically, the outward edge of the side wall part 16 covers the surface of both peripheral parts of the tread part 13 on the circumference of the tire to form the shoulder part 17 constituting the tread ground contact edge region.

The side wall part 16 of the tire 10 has a side wall cushion rubber 25 disposed on the tire inside face side of the side wall rubber 22, and is contacted with the rim strip 19, a carcass 14 and the edge of the tread rubber 21 to form a barrier layer which increases adhesion between different kinds of rubbers.

In the tire 10 having an SWOT structure, the side wall part 16 is extended outward in a radial direction of the tire from the bead part 11 to integrally form the shoulder part 17 constituting the ground contact edge region, and the top part 25a of the cushion rubber 25 is exposed to the surface of the ground contact edge region.

The tire 10 shows a tire for passenger car having a radial structure having the carcass 14 in which two carcass plies comprising a cord provided in the radial direction around a bead core 12 embedded in each of a pair of the bead parts 11 are turned back outward from the inside of the tire and locked, a belt 18 comprising two crossed belt plies provided inward the tread part 13, and one cap ply 20 comprising a cord helically wound at an angle of nearly 0° to a circumferential direction of the tire, on the outer circumference of the belt 18.

An organic fiber cord such as polyester, nylon or rayon is used in a carcass ply of the carcass 14 as a reinforcing material, a rigid cord such as steel cord or aramide fiber is used in a belt ply of the belt 18 as a reinforcing material, and a cord having relatively large heat shrinkability such as nylon or polyester is used in a cap ply 20 as a reinforcing material.

A rubber composition using non-carbon black reinforcing agents such as silicas such as precipitated silica or silicic anhydride, clays such as calcined clay or hard clay, and calcium carbonate as a reinforcing agent in place of the conventional carbon black as a reinforcing agent is used in a tread rubber 21 of the crown part 15 constituting a main ground contact part of the tread part 13 so as to decrease tan δ of a rubber composition in order to contribute to the improvement of rolling resistance and wet properties of the tire 10. Silica having large improvement effect on rolling resistance and the like is particularly preferably used.

The compounding amount of the non-carbon black reinforcing agent such as silica varies depending on the kind of carbon black and the substitution amount, but is generally from 30 to 100 parts by weight, and preferably from 40 to 80 parts by weight, per 100 parts by weight of the rubber component.

In the case of silica, the kind of silica is not particularly limited. Wet silica having nitrogen adsorption specific area (BET) of from 100 to 250 m²/g and DBP oil absorption of 100 ml/100 g or more is preferred in reinforcing effect and processability, and the commercially available products such as NIPSIL AQ and VN3, manufactured by Tosoh Silica Corporation, and ULTRASIL VN3, manufactured by Degussa can be used. Furthermore, the combination use of a silane coupling agent such as bis(triethoxysilylpropyl)-tetrasulfide is preferred.

As carbon black in the tread rubber 21, SAF, ISAF, HAF and the like are preferred in abrasion resistance and exothermic properties.

Diene rubbers such as natural rubber (NR), isoprene rubber (IR), styrene-butadiene rubber (SBR) and butadiene rubber (BR) are generally used as a rubber component in the rubber composition of the tread rubber 21. Those are used alone or as a blend rubber. Furthermore, oils of rubber compounding agent, softeners such as wax, stearic acid, zinc white, resins, age resistors, vulcanizing agents such as sulfur, vulcanization accelerators, and the like are appropriately compounded.

Furthermore, to enhance improvement effects on rolling resistance and the like, the tire 10 uses a rubber composition containing the non-carbon black reinforcing agent as a reinforcing agent in an amount of from 30 to 100 parts by weight per 100 parts by weight of the rubber component in the side wall rubber 22 of the side wall part 16, simultaneously with the tread rubber.

The nonconductive side wall 22 is obtained by containing diene rubbers such as NR, IR, SBR, BR or butadiene rubber (VCR) containing syndiotactic-1,2-polybutadiene, alone or as blends thereof, as a rubber component, and carbon black having nitrogen adsorption specific surface area (N₂SA) of from 25 to 100 m²/g in an amount less than 14 vol % of the entire rubber composition.

Furthermore, where N₂SA of carbon black is less than 25 m²/g, durability is decreased due to decrease in strength of the rubber composition, and where N₂SA exceeds 100 m²/g, hysteresis loss is increased, resulting in increase in rolling resistance and generation of heat.

Carbon black having N₂SA of from 25 to 100 m²/g includes carbon blacks of HAF, FEF and GPF grades.

Non-carbon black reinforcing agent such as silica, clay or calcium carbonate may be used in an appropriate amount in combination with carbon black. Furthermore, oils of rubber compounding agent, softeners such as wax, stearic acid, zinc white, resins, age resistors, vulcanizing agents such as sulfur, vulcanization accelerators, and the like are appropriately compounded.

By this, the tread rubber 21 and the side wall rubber 22 improve rolling resistance and wet properties, but on the other hand, the rubber compositions have electric resistivity of 10⁸Ω·cm or more, and form nonconductive rubbers. As a result, the tread ground contact part and the side wall part 16 become nonconductive, the tire 10 becomes a nonconductive tire having electric resistance of 10⁹Ω or more by the combination of each member, and static electricity charged in vehicles cannot be discharged to road surface from the tread part 13.

To solve the problem on static electricity charged in vehicles, the tire 10 of the present embodiment is that a conductive rubber having electric resistivity less than 10⁸Ω·cm is applied to the rim strip rubber 23 and the side wall cushion rubber 25 on the circumference of the tire 10 in at least one side part of the tire. By this, the rim strip rubber 23 and the side wall cushion rubber 25 form a continuous conductive path.

The tire 10 uses only the conductive path as a conducting path, and static electricity of vehicles is discharged to road surface from the top part 25a of the side wall cushion rubber
exposed to the surface of the ground contact edge region through the rim strip rubber 23 and the side wall cushion rubber 25 from the rim.

The conductive rubber composition can easily be obtained by appropriately adjusting the compounding amount of carbon black, and it is desired that the rubber composition has electric resistivity preferably less than 10⁷Ω·cm.

The conductive side wall cushion rubber 25 is obtained by containing diene rubbers such as NR, IR, SBR, BR or VCR, alone or as blends thereof, as a rubber component, and carbon black having N₂SA of from 25 to 100 m²/g in an amount of 14 vol % or more of the entire rubber composition.

Where the amount of carbon black is less than 14 vol %, electric resistivity of the rubber composition is 10⁸Ω·cm or more, resulting in deterioration of conductivity. Furthermore, where N₂SA of carbon black is less than 25 m²/g, durability is decreased due to decrease in strength of the rubber composition, and where N₂SA exceeds 100 m²/g, hysteresis loss is increased, resulting in increase in rolling resistance and generation of heat.

Carbon black having N₂SA of from 25 to 100 m²/g includes carbon blacks of HAF, FEF and GPF grades.

Non-carbon black reinforcing agent such as silica, clay or calcium carbonate may be used in an appropriate amount in combination with carbon black. Furthermore, oils of rubber compounding agent, softeners such as wax, stearic acid, zinc white, resins, age resistors, vulcanizing agents such as sulfur, vulcanization accelerators, and the like are appropriately compounded.

Members other than the conducting path (that is, the rim strip rubber 23 and the side wall cushion rubber 25) of the tire 10 can be selected from a conductive rubber material or a nonconductive rubber material so long as a conducting path is not formed.

For example, in the case that the conductive side wall cushion rubber 25 is applied to only one side part of the tire 10, a nonconductive rubber having electric resistivity of 10⁸Ω·cm or more can be applied to the other side part. By this, rolling resistance and wet properties of the tire 10 can further be improved by the increase in the amount of the nonconductive rubber used. In this case, electric resistance of the tire 10 is slightly increased as compared with the case that the conductive rubber is applied to the side wall cushion rubbers of both side parts. However, discharge properties of static electricity are not greatly decreased, and there is no practical problem.

The nonconductive side wall cushion rubber is obtained by changing only the compounding amount of carbon black in the conductive rubber. That is, the nonconductive side wall cushion rubber is a rubber composition containing carbon black having N₂SA of from 25 to 100 m²/g in an amount less than 14 vol % of the entire rubber composition.

Where the amount of carbon black is 14 vol % or more, the rubber composition has electric resistivity less than 10⁸Ω·cm, and thus has conductivity. However, improvement effect on rolling resistance is not obtained.

The conductive rim strip rubber 23 contains diene rubbers such as NR, IR, SBR, BR or VCR alone or as blends thereof, as a rubber component, and carbon black having N₂SA of from 70 to 100 m²/g in an amount of 14 vol % or more of the entire rubber composition.

Where the amount of carbon black is less than 14 vol %, electric resistivity of the rubber composition is 10⁸Ω·cm or more, resulting in deterioration of conductivity. Furthermore, where N₂SA of carbon black is less than 70 m²/g, the bead part is liable to be damaged due to rim rubbing by decrease in abrasion resistance of the rubber composition, and where N₂SA exceeds 100 m²/g, hysteresis loss deteriorates, resulting in increase in rolling resistance and generation of heat.

Carbon black having N₂SA of from 70 to 100 m²/g includes carbon black of HAF grade.

Non-carbon black reinforcing agent such as silica, clay or calcium carbonate may be used in an appropriate amount in combination with carbon black. Furthermore, oils of rubber compounding agent, softeners such as wax, stearic acid, zinc white, resins, age resistors, vulcanizing agents such as sulfur, vulcanization accelerators, and the like are appropriately compounded.

In the case that a conductive rubber is applied to only the side wall cushion rubber 25 of one side part, the conductive rubber is also applied to the rim strip rubber 23 at the same side. That is, conductivity of a tire can be secured by applying the conductive rubber to the side wall cushion rubber 25 and the rim strip rubber 23 in pairs at unilateral or bilateral side portions of the tire 10.

In the tire 10 shown in FIG. 1, the tread rubber 21 shows a tread of integrated structure. In the case that the tread part 13 has a cap/base structure, a nonconductive rubber is applied to a cap rubber from the standpoints of rolling resistance and wet properties. A base rubber can appropriately be selected from conductive and nonconductive rubbers. Other sites of the tire 10 such as topping rubber of a carcass or a belt, and bead filler can appropriately be selected from conductive and nonconductive rubbers so long as a conducting path is not formed. A nonconductive rubber is preferably selected from the standpoint of the improvement in rolling resistance and wet properties.

### Second Embodiment

FIG. 2 is a semi-sectional view showing a pneumatic tire 30 of a second embodiment.

The pneumatic tire 30 comprises a pair of bead parts 31 to be mounted on a rim, a side wall part 36 extending outward in radial direction of the tire from the bead part 31, and a tread part 33 ground-contacted to road surface laid between the side wall parts 36, 36, and the tread part 33 comprises a crown part 35 constituting a main ground contact part at the central portion in a width direction of the tire, and a shoulder part 37 positioned at both sides of the tread part 33 to form a ground contact edge region and being continuous to the side wall part 36.

The tire 30 has a rim strip 39 contacting with a flange of a rim arranged outward in a radial direction of the bead part 31, and the lower edge of the side wall part 36 is contacted with the rim strip 39 by overlapping on the upper edge thereof.

The tire 30 has a tread-over-side wall (TOS) structure in which the both edges of the tread part 33 are overlapped on the outward edge of the side wall part 36, as shown in FIG. 2.

A wing rubber 44 positioned at the shoulder part 37 constituting a ground contact edge region at both edges in an axial direction of the tire of the tread part 33 and contacted with the side wall part 36 to form the surface of the shoulder part 37 is provided on the circumference of the tire. That is, the wing rubber 44 is provided so as to contact with the edge of the tread rubber 41 and the upper edge of a side wall rubber 42 in a bridged state.

The side wall part 36 of the tire 30 has the side wall cushion rubber 45 disposed on the tire inside face side of the side wall rubber 42, and is contacted with the rim strip 39, the carcass 34 and the edge of the tread rubber 41 to form a barrier layer which increases adhesion between different kinds of rubbers.

In the tire 30 having a TOS structure, the side wall rubber 42 is extended outward in a radial direction of the tire from the bead part 31, and positioned at the inside face side of wing rubber 44 in the shoulder part 37 constituting the ground contact edge region.

In the present embodiment, the side wall cushion rubber 45 is extended from the top part of the side wall rubber 42 to provide an extended part 45a as shown in FIG. 3(a), and the extended part 45a is used by turning back outward as shown in FIG. 3(b). As a result, the side wall cushion rubber 45 is contacted with the lower edge of the wing rubber 44, thereby a conducting path can be secured.

A method of contacting the side wall cushion rubber 45 with the wing rubber 44 is not limited to the above method, and can use any method so long as the cushion rubber 45 is contacted with the wing rubber 44.

The tire 30 shows a tire for passenger car having a radial structure having the carcass 34 in which two carcass plies comprising a cord provided in the radial direction around a bead core 32 embedded in each of a pair of the bead parts 31 are turned back outward from the inside of the tire and locked, a belt 38 comprising two crossed belt plies provided inward the tread part 33, and one cap ply 40 comprising a cord helically wound at an angle of nearly 0° to the circumferential direction of the tire, on the outer circumference of the belt 38.

An organic fiber cord such as polyester, nylon or rayon is used in a carcass ply of the carcass 34 as a reinforcing material, a rigid cord such as steel cord or aramide fiber is used in a belt ply of the belt ply 38 as a reinforcing material, and a cord having relatively large heat shrinkability such as nylon or polyester is used in a cap ply 40 as a reinforcing material.

A rubber composition using non-carbon black reinforcing agents such as silica, clay and calcium carbonate as a reinforcing agent in place of the conventional carbon black as a reinforcing agent is used in a tread rubber 41 so as to decrease tan δ of a rubber composition in order to contribute to the improvement of rolling resistance and wet properties, similar to the tire 10. A rubber composition by the same formulation as in the tread rubber 21 described in the above first embodiment is used, and the rubber composition forms a nonconductive rubber having electric resistivity of 10⁸Ω·cm or more.

Furthermore, to enhance improvement effects on rolling resistance and the like, a rubber composition containing the non-carbon black reinforcing agent as a reinforcing agent in an amount of from 30 to 100 parts by weight per 100 parts by weight of the rubber component is used in the side wall rubber 42 of the side wall part 36, simultaneously with the tread rubber.

The nonconductive side wall 42 is obtained by containing diene rubbers such as NR, IR, SBR, BR or VCR alone or as blends thereof, as a rubber component, and carbon black having N₂SA of from 25 to 100 m²/g in an amount less than 14 vol % of the entire rubber composition.

Where N₂SA of carbon black is less than 25 m²/g, durability is decreased due to decrease in strength of the rubber composition, and where N₂SA exceeds 100 m²/g, hysteresis loss is increased, resulting in increase in rolling resistance and generation of heat.

Carbon black having N₂SA of from 25 to 100 m²/g includes carbon blacks of HAF, FEF and GPF grades.

Non-carbon black reinforcing agent such as silica, clay or calcium carbonate may be used in an appropriate amount in combination with carbon black. Furthermore, oils of rubber compounding agent, softeners such as wax, stearic acid, zinc white, resins, age resistors, vulcanizing agents such as sulfur, vulcanization accelerators, and the like are appropriately compounded.

By this, the tread rubber 41 and the side wall rubber 42 improve rolling resistance and wet properties, but on the other hand, the rubber compositions have electric resistivity of 10⁸Ω·cm or more, and form nonconductive rubbers having electric resistance of 10⁹Ω or more. As a result, static electricity charged in vehicles cannot be discharged to road surface from the tread part 33 through the rim strip rubber 43 of the bead part 31 and the side wall rubber 42 of the side wall part 36 from the rim.

To solve the problem on static electricity charged in vehicles, the tire 30 of the present embodiment is that a conductive rubber having electric resistivity less than 10⁸Ω·cm is applied to the rim strip rubber 43, the side wall cushion rubber 45 and the wing rubber 44 in at least one side part of the tire. By this, a continuous conductive path is formed over from the rim strip 39 to the wing 44.

The tire 30 uses only the conductive path as a conducting path, and static electricity of vehicles is discharged to road surface from the rim strip rubber 43 and the side wall cushion rubber 45 through the wing rubber 44 contacting with the turnover part 45a of the cushion rubber from the rim.

The conductive rubber composition can easily be obtained by appropriately adjusting the compounding amount of carbon black, and it is desired that the rubber composition has electric resistivity preferably less than 10⁷Ω·cm.

The rubber compositions by the same formulations as in the side wall rubber 25 and rim strip rubber 23 described in the first embodiment are used in the conductive side wall cushion rubber 45 and rim strip rubber 43, thereby a conductive rubber having electric conductivity less than 10⁸Ω·cm can be formed.

The conductive wing rubber 44 can apply a rubber composition containing diene rubbers such as NR, IR, SBR, BR or VCR alone or as blends thereof, as a rubber component, and carbon black having N₂SA of from 25 to 100 m²/g in an amount of 14 vol % or more of the entire rubber composition.

Where the amount of carbon black is less than 14 vol %, electric resistivity of the rubber composition is 10⁸Ω·cm or more, resulting in deterioration of conductivity. Furthermore, where N₂SA of carbon black is less than 25 m²/g, durability is decreased due to decrease in strength of the rubber composition, and where N₂SA exceeds 100 m²/g, hysteresis loss deteriorates, resulting in increase in rolling resistance and generation of heat.

Carbon black having N₂SA of from 25 to 100 m²/g includes carbon blacks of HAF, FEF and GPF grades.

Non-carbon black reinforcing agent such as silica, clay or calcium carbonate may be used in an appropriate amount in combination with carbon black. Furthermore, oils of rubber compounding agent, softeners such as wax, stearic acid, zinc white, resins, age resistors, vulcanizing agents such as sulfur, vulcanization accelerators, and the like are appropriately compounded.

Members other than the conducting path (that is, the rim strip rubber 43, the side wall cushion rubber 45 and the wing rubber 44) of the tire 30 can be selected from a conductive rubber material or a nonconductive rubber material so long as a conducting path is not formed.

For example, in the case that the conductive side wall cushion rubber 45, rim strip rubber 43 and wing rubber 44 are applied to only one side part of the tire 30, a nonconductive rubber having electric resistivity of 10⁸Ω·cm or more having compounded therewith a non-carbon black reinforcing agent may be applied to the other side part. By this, rolling resistance and wet properties of the tire 30 can be improved. In this case, electric resistance of the tire is slightly increased as compared with the case that the conductive rubber is disposed at both side parts. However, discharge properties of static electricity are not greatly decreased, and there is no practical problem.

The nonconductive wing rubber 44 is obtained by changing only the compounding amount of carbon black in the conductive wing rubber. That is, the nonconductive wing rubber is a rubber composition containing carbon black having N₂SA of from 25 to 100 m²/g in an amount of less than 14 vol % of the entire rubber composition.

Where the amount of carbon black is 14 vol % or more, the rubber composition has electric resistivity less than 10⁸Ω·cm, and thus has conductivity. However, improvement effect on rolling resistance is not sufficiently obtained.

Needless to say, a conductive rubber is applied to the three of the side wall cushion rubber 45, the rim strip rubber 43 and the wing rubber 44 in pairs, thereby securing conductivity of the tire 30.

In the tire 30, in the case that the tread part 33 has a cap/base structure, a nonconductive rubber is applied to a cap, but a base can appropriately be selected from a conductive or nonconductive rubber. Other sites of the tire 30 such as topping rubber of a carcass or a belt, and bead filler can appropriately be selected from a conductive or nonconductive rubber so long as a conducting path is not formed. A nonconductive rubber is preferably selected from the standpoint of improvement in rolling resistance and wet properties.

### Third Embodiment

A third embodiment is an embodiment that a formation method of a side wall cushion rubber is changed, and the present embodiment is described using the sectional view of the tire 10 of FIG. 1.

Conventionally, the side wall cushion rubber 25 of the first embodiment is generally obtained by a method in which the sheet-like cushion rubber 25 having a thickness of about 0.2 to 1.0 mm extruded from a rubber extruding machine is adhered to the tire inside face side of the side wall rubber 22 separately extrusion molded, following the extrusion molding of the cushion rubber 25, thereby forming a cushion layer.

Furthermore, a cushion rubber sheet obtained by rolling processing by calendaring or the like may be adhered to the tire inside face side of the side wall rubber 22 previously extrusion molded to integrate with the side wall rubber.

However, the conventional method requires that cushion rubbers having different width and thickness are subjected to extrusion molding and rolling processing according to category, size and the like of tires. This gives rise to the problems that production efficiency is damaged and additional facilities such as extruding machine is required.

In view of the above, in the present embodiment, a thin ribbon-like strip rubber continuously containing a conductive rubber having electric resistivity less than 10⁸Ω·cm in a longitudinal direction is continuously and helically wound in nearly circumferential direction of the side wall part 16 over from the rim strip 19 of the bead part 11 to the shoulder part at the time of fabricating a green tire, thereby forming the side wall cushion rubber 25. This method is a fabricating method called a strip-build method. Additional facilities such as the extruding machine are not necessary, and productivity is improved.

In this case, it is preferred that the ribbon-like strip rubber is wound so as to mutually contact the ribbon edges. Where the ribbon edges are mutually overlapped or space is formed between the ribbons, unevenness is possibly generated on the outer face of the side part, and tire appearance quality may be damaged.

The ribbon-shaped strip rubber may be that the whole strip comprises a conductive rubber, but a conductive rubber may continuously be contained in a part of a ribbon-shaped section comprising a nonconductive rubber in a longitudinal direction.

In the case of the latter, the conductive rubber portion is contacted with the rim strip 19, and simultaneously exposed to the surface of the ground contact part in the shoulder part 17. By this, a conducting path in which a conductive rubber is spirally provided on the side wall part 16 is formed, and static electricity of vehicles can be discharged to road surface from the strip rubber 23 through the cushion rubber 25. In this case, a rubber composition that can contribute to the improvement of rolling resistance and the like can be used in a nonconductive rubber.

The double structure strip rubber is obtained by bonding ribbons comprising a conductive rubber and a nonconductive rubber. For example, it is considered that a ribbon-like conductive rubber and a nonconductive rubber are contacted at their edges in a ribbon-like width direction to joint those, thereby forming one ribbon.

The strip-build method can also be applied to the tire 30 of a TOS structure as shown in FIG. 2.

The strip-build method can also be employed in the formation of a side wall comprising a nonconductive rubber. Furthermore, the rim strip 19 and the wing rubber 44 can be formed by the strip-build method.

### EXAMPLES

The present invention is specifically described based on the Examples, but the invention is not construed as being limited thereto.

Rubber compositions for rim strip and side wall cushion were prepared by kneading a conductive rubber and a nonconductive rubber, in which the compounding amount of carbon black is adjusted, and a rubber composition for a tread by silica compounding according to the formulation (parts by weight) shown in Table 1 by the ordinary method using a Banbury mixer having a volume of 200 liters. Rubber components and compounding agents used are as follows. Vol % of carbon black is a calculated value from the compounding amount (parts by weight).

Natural rubber (NR): RSS #3, made in Thailand

Butadiene rubber (BR): BR150B, Ube Industries, Ltd.

Styrene-butadiene rubber (SBR): 1502, JSR Corporation

Carbon black HAF for rim strip rubber: SEAST 3, Tokai Carbon Co., Ltd.

Carbon black FEF for side wall cushion rubber: SEAST SO, Tokai Carbon Co., Ltd.

Carbon black ISAF for tread rubber: SEAST 6, Tokai Carbon Co., Ltd.

Silica: NIPSIL AQ, Tosoh Silica Corporation

Silane coupling agent: Si69, Degussa

Aroma oil: X-140, Japan Energy Corporation

Paraffin wax: OZOACE-0355, Nippon Seiro Co., Ltd.

Age resistor 6C: NOCRAC 6C, Ouchi Shinko Chemical Industrial Co., Ltd.

Stearic acid: RUNAX S-20, Kao Corporation

Zinc oxide: ZINC WHITE #1, Mitsui Mining & Smelting Co., Ltd.

Sulfur: 5% oil-treated powdery sulfur, Hosoi Chemical Industry Co., Ltd.

Vulcanization accelerator NS: NOCCELER NS-P, Ouchi Shinko Chemical Industry Co., Ltd.

Electric resistivity of each rubber composition was measured according to JIS K6911, and is shown in Table 1. The measurement conditions were voltage applied: 1,000V, temperature: 25° C., and humidity: 50%.

TABLE 1

| | | Rim strip | | Side wall cushion | | Tread rubber |
|---|---|---|---|---|---|---|
| | | Conductive | Nonconductive | Conductive | Nonconductive | Nonconductive |
| Formulation | NR | 70 | 70 | 60 | 60 | 50 |
| | BR | 30 | 30 | 40 | 40 | |
| | SBR | | | | | 50 |
| | Carbon black | 70 | 30 | 50 | 30 | |
| | Silica | | | | | 60 |
| | Silane coupling agent | | | | | 4 |
| | Aroma oil | 3 | 3 | 10 | 10 | 20 |
| | Wax | 1 | 1 | | | 3 |
| | Age resistor | 2 | 2 | 1 | 1 | 2 |
| | Stearic acid | 2 | 2 | 2 | 2 | 2 |
| | Zinc oxide | 3 | 3 | 3 | 3 | 3 |
| | Sulfur | 2 | 2 | 2 | 2 | 2 |
| | Vulcanization accelerator | 1.5 | 1.5 | 1 | 1 | 1.5 |
| | Carbon black (vol %) | 20 | 12 | 16 | 12 | 0 |
| | Electric resistivity (Ω · cm) | 7 × 10⁶ | 2 × 10¹² | 2 × 10⁷ | 7 × 10¹² | 3 × 10¹³ |

Radial tires (195/65R15 88S) of SWOT structure as shown in FIG. 1 in which the rim strip rubber and the side wall cushion rubber were changed to a conductive rubber (indicated by “o” in Table 2) or a nonconductive rubber (indicated by “x” in Table 2) were produced according to the combination shown in Table 2 using the rubber compositions obtained, and electric resistance and rolling resistance were measured by the following methods. Comparative Example 5 is that a conductive rubber sheet (electric resistivity=2×10⁷Ω·cm) with carbon black compounding having a thickness of 0.2 mm and a width of 10 cm was adhered over an area of from a rim strip to a tread, thereby securing conductivity of a tire. Regarding a tread rubber, the tread rubber shown in Table 1 was commonly used in each tire.

As the side wall cushion rubber, a cushion rubber was extrusion molded into a sheet-like shape having a thickness of 0.3 mm using the rubber compositions for the cushion shown in Table 1 by a rubber extruding machine, and a green tire was fabricated using a member obtained by pasted and integrated to the tire inner side of a side wall rubber which was separately extrusion molded in succession to the extrusion molding of the cushion rubber.

Furthermore, one ply of a polyester cord of 1670 dtex/2 was commonly used as a carcass (count: 22/25 mm), two plies (cross angle: 45°) of a steel cord of 2+2×0.25 were commonly used as a belt (count: 18/25 mm), and one sheet structure of nylon 66 cord of 940 dtex/2 was commonly used as a cap ply (count: 28/25 mm).

Electric resistance of a tire was measured as follows. The tire 10 was mounted on a standard rim R (15×6 JJ) with air pressure of 200 kPa, and the rim with the tire was attached to a FF type domestic car of 1,600 cc displacement. After running the car as trial run at 100 km per hour for 3 hours, the electric resistance was measured based on “Measurement procedures of electric resistance of tire under load” specified in WDK, Blatt 3, Germany. Specifically, as shown in FIG. 4, the tire 10 mounted on the rim was vertically ground-contacted on a copper plate 131 placed on a table plate 130 in an electrically insulated state under a load of 400 kg, and electric resistance between the central portion of the standard rim R and the copper plate 131 was measured using a resistance meter of applied voltage of 1,000 V. At the time of measurement, temperature is 25° C. and humidity is 50%. The results are shown in Table 2.

The rolling resistance was measured as follows. A tire was mounted on a standard rim with air pressure of 200 kPa, and rolling resistance under a load of 400 kg at 60 km per hour was measured using a uniaxial drum tester for measurement of rolling resistance. The result was indicated by an index as the value of Comparative Example 1 being 100. The larger value indicates that rolling resistance is higher and fuel consumption property is poorer. The results obtained are shown in Table 2.

TABLE 2

| | Position of | | | Comparative | Comparative | Comparative | Comparative | Comparative |
|---|---|---|---|---|---|---|---|---|
| | side | Example 1 | Example 2 | Example 1 | Example 2 | Example 3 | Example 4 | Example 4 |
| Side wall cushion | Serial side | ∘ | ∘ | x | x | ∘ | ∘ | x |
| | Antiserial | ∘ | x | x | x | ∘ | x | x |
| | side | | | | | | | |
| Rim strip | Serial side | ∘ | ∘ | x | ∘ | x | x | ∘ |
| | Antiserial | ∘ | x | x | ∘ | x | ∘ | ∘ |
| | side | | | | | | | |
| Other | | | | | | | | *1 |
| Electric | | 1 | 6 | 10,000 or | 10,000 Or | 10,000 or | 10,000 or | 2 |
| resistance (10⁶ Ω) | | | | more | more | more | more | |
| Rolling resistance | | 104 | 102 | 100 | 102 | 102 | 102 | 110 |
| (Index) | | | | | | | | |

*1: Conductive rubber sheet was adhered to the surface of the side wall at both sides over from a rim strip to a tread.

### INDUSTRIAL APPLICABILITY

The pneumatic tire of the present invention can be used in various vehicles such as four-wheel cars such as passenger cars, and additionally two-wheel cars such as motorcycles, three-wheel cars, and five-wheel or more buses, trailers and industrial vehicles.

### BRIEF DESCRIPTION OF THE DRAWINGS

FIG. 1 is a semi-sectional view of a pneumatic tire of a first embodiment.

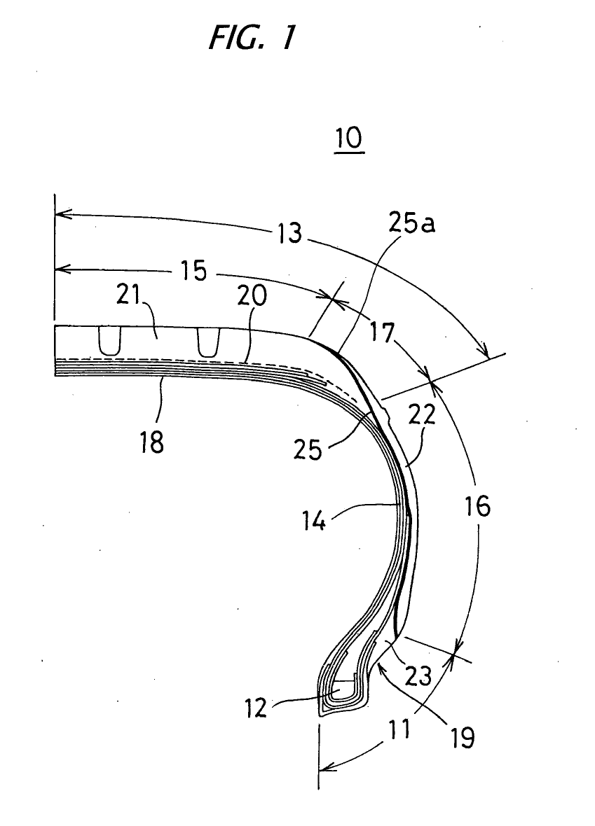

FIG. 2 is a semi-sectional view of a pneumatic tire of a second embodiment.

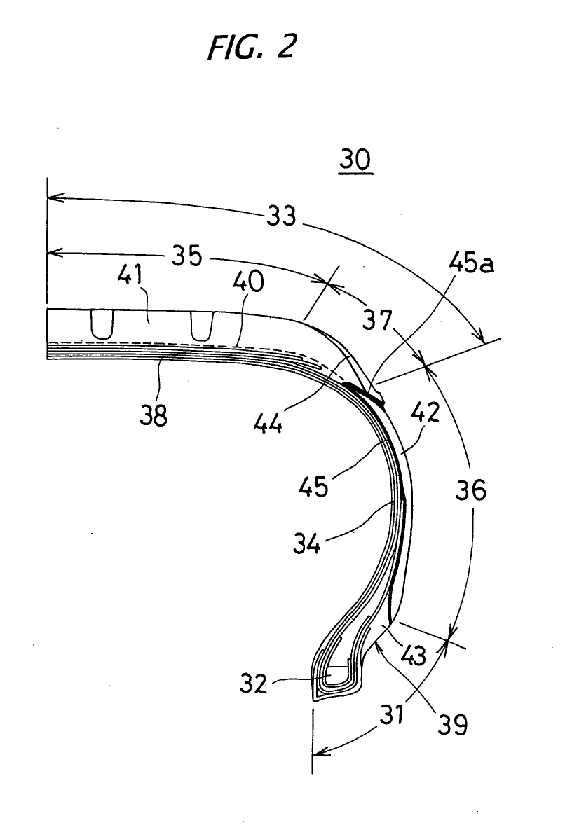

FIG. 3 is a side wall sectional view showing the top part of a side wall cushion rubber of a second embodiment.

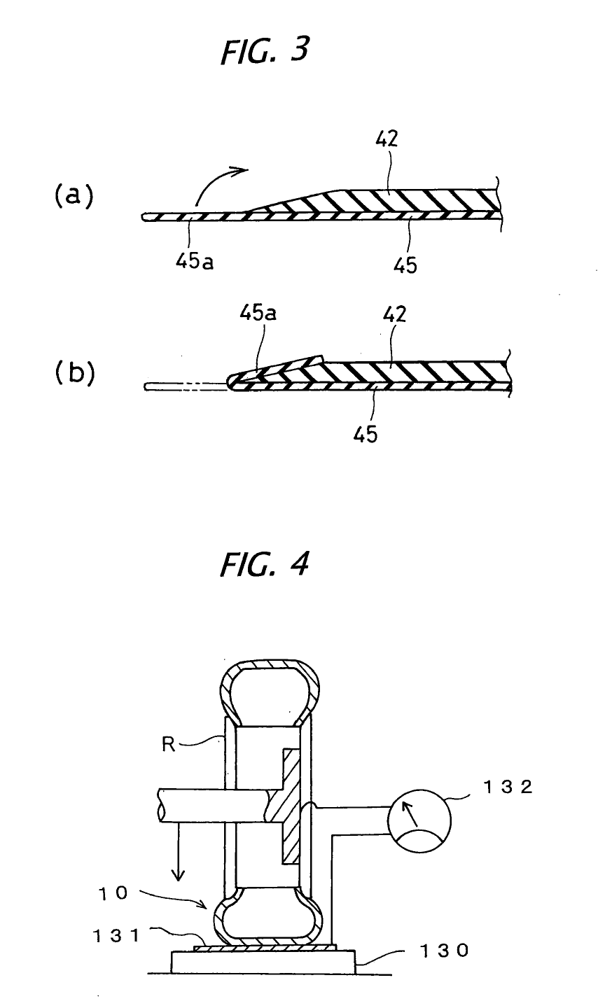

FIG. 4 is a schematic view showing a measurement method of electric resistance of a tire.
10: Pneumatic tire
11: Bead part
13: Tread part
16: Side wall
19: Rim strip
25: Cushion rubber

1. A pneumatic tire having a sheet-like cushion rubber having a thickness of 1 mm or less, disposed on a tire inside face side of a side wall rubber, the cushion rubber being in contact with a rim strip and coupled to a ground contact edge region of a tread part through a side wall part;
wherein on the circumference of unilateral or bilateral side portions of the tire, the rim strip, the cushion rubber and at least the surface part of the ground contact edge region are formed into a continuous conductive path by a conductive rubber material, only the conductive path is used as a conducting path of the tire, and members other than the conducting path are selected and used from a conductive rubber material or a nonconductive rubber material.

2. The pneumatic tire as claimed in claim 1, wherein the outward edge in a radial direction of the tire of the side wall rubber integrally forms the ground contact edge region, and the top part of the cushion rubber is exposed to the surface of the ground contact edge region.

3. The pneumatic tire as claimed in claim 1, wherein the tire has a wing disposed at both edges in an axial direction of the tire of the tread part and contacted with the side wall rubber to form the surface part of the ground contact edge region, and the top part of the cushion rubber is contacted with the wing.

4. The pneumatic tire as claimed in any one of claims 1 to 3, wherein the conductive rubber material is a rubber composition having electric resistivity less than 10⁸Ω·cm.

5. The pneumatic tire as claimed in claim 4, wherein the rubber composition comprises a diene rubber as a rubber component, and carbon black having a nitrogen adsorption specific area of from 25 to 100 m²/g in an amount of 14 vol % or more of the entire rubber composition.

6. The pneumatic tire as claimed in claim 1, wherein the nonconductive rubber material comprises a rubber composition containing a non-carbon black reinforcing agent as a reinforcing agent.

7. The pneumatic tire as claimed in claim 6, wherein the non-carbon black reinforcing agent is silica.
